(19) United States
(12) Patent Application Publication
(10) Pub. No.: US 2008/0207047 A1
(43) Pub. Date: Aug. 28, 2008

(54) Wall Box Device

(76) Inventor: Michael Peter Walton, (US)

Correspondence Address: MICHAEL P. WALTON, 2830 BRISTOL ROAD, WARRINGTON, PA, 18976-1408, US

(21) Appl. No.: 11/679,511

(22) Filed: Feb. 27, 2007

(51) Int. Cl. H02G 3/08; H02G 3/18; H02G 3/10

(52) U.S. Cl. 439/538; 174/54; 220/3.2

(57) ABSTRACT

A wall box device comprising a clip extending from an elongated body, for use with non metallic electrical wall boxes. The metal clip is capable of providing an attachment point for the yoke of electrical devices. The clips are secured in place by a plurality of barbs extending outwardly and upwardly therefrom. The barbs allow easy insertion of the clip onto the box, while preventing withdrawal or removal. The attachment point can include a new threaded opening to receive a machine screw, the new threaded opening taking the place of the original worn threaded opening.

### BACKGROUND OF THE INVENTION

1. Field of Invention

This invention relates generally to electrical wall boxes made of PVC and/or other forms of plastic or resins that are installed in partitions, walls, floors, ceilings of buildings or homes and, more particularly, to a repair clip for use with these type plastic boxes in such installations.

2. Description of Related Art and Brief Summary of the Invention

Electrical devices are installed and wired in enclosures within the walls, floors, ceilings and partitions of a building's construction.

These enclosures when installed during construction are considered “New Work” type and when installed after the initial building construction are considered “Old Work” type.

Enclosures that are installed for the purpose of housing switches, outlets and various other electrical devices of various voltages are commonly called “wall boxes” or “wall cases” or “outlet boxes”.

These boxes are installed in each room and location and are interconnected by electrical conductors and wires which supply the electrical current to a device mounted/installed in said boxes. Each device installed in a wall box represents one gang. Thus, a wall box enclosing two devices would be a two gang wall box and a box with three devices would be a three gang box and so on.

The wall boxes facilitate the safe mounting/attachment and housing of the various devices (both low and line voltage and telecommunication) by means of two mounting attach points (per device/gang). These mounting/attaching points are threaded female recesses, in the body of the wall case, which accept the standard 6-32 machine screws used to secure the yoke of the devices being mounted.

The electrical industry has moved from the use of metal wall boxes towards an extensive use of boxes made of PVC, plastic and other resin in new construction.

Installation of the wall boxes is made to structural members such as studs and joist composed of wood and/or metal, by means of nails and/or screws. The electrical conductors and/or circuits are then installed and enter the wall box through openings designed and intended for that purpose prior to the installation of the wall board, drywall, plaster and/or other interior wall products.

In the prior art installation described above, it has been discovered that such assemblies have certain disadvantages, namely, that over time and for various reasons, the attachment point for the two machine screws, become brittle and the threads deteriorate to a condition that the box can no longer maintain a secure attachment to the yoke of the electrical device, resulting in the device becoming loose and rendering the wall box unserviceable and requiring removal and replacement. This removal and replacement of the wall box while installed within a finished wall is time consuming, expensive and often requires damage to the wall materials and finished surface of the wall.

U.S. Pat. No. 5,627,340 has suggested an activation ring comprising retaining clips with barbs. But, such activation ring is for an entirely different purpose and has nothing to do with providing an attachment point having a threaded opening to receive a machine screw.

U.S. Pat. No. 5,823,821 shows an apparatus for securing an electrical outlet to an outlet box. But, at FIG. 2 of the '821 patent, the end of a flat tab has a radius and turns upward. This could result in pinching and damage of existing electrical conductors. Also, the outside plate if manufactured as shown in the '821 patent, the outside plate would not be able to be used on a “Nail-On” box.

### SUMMARY OF THE INVENTION

It is the object of this invention to provide a means to repair/restore the plastic box to a state or condition of serviceability.

In particular, an object of this invention is to provide an improved attachment point to the existing plastic wall box without requiring the removal of the box from within the wall.

In order to achieve these and other objects, the present invention comprises a metal clip assembly which has a tab capable of accepting a 6-32 machine screw thread. This metal clip is fastened in place to the wall of the plastic box without the use of adhesives.

In the preferred embodiment of this invention, the clip assembly is secured to the existing wall box by gripping means having a plurality of barbs extending from the metal clip, the barbs being operative to engage the plastic surface of the existing wall box and preventing the clips dislodgement.

The above stated and other objects will become apparent to those skilled in the art upon reading the following detailed description in conjunction with the appended drawings.

It is to be fully understood, however, that the assemblies disclosed herein may be easily adapted to accommodate a plurality of gang box sizes and that numerous modifications may be made in the preferred embodiments without departing from the spirit and scope of this invention. Accordingly, the scope of coverage provided by this patent should be limited only by the claims and art.

### DETAILED DESCRIPTION OF THE DRAWING AND THE INVENTION

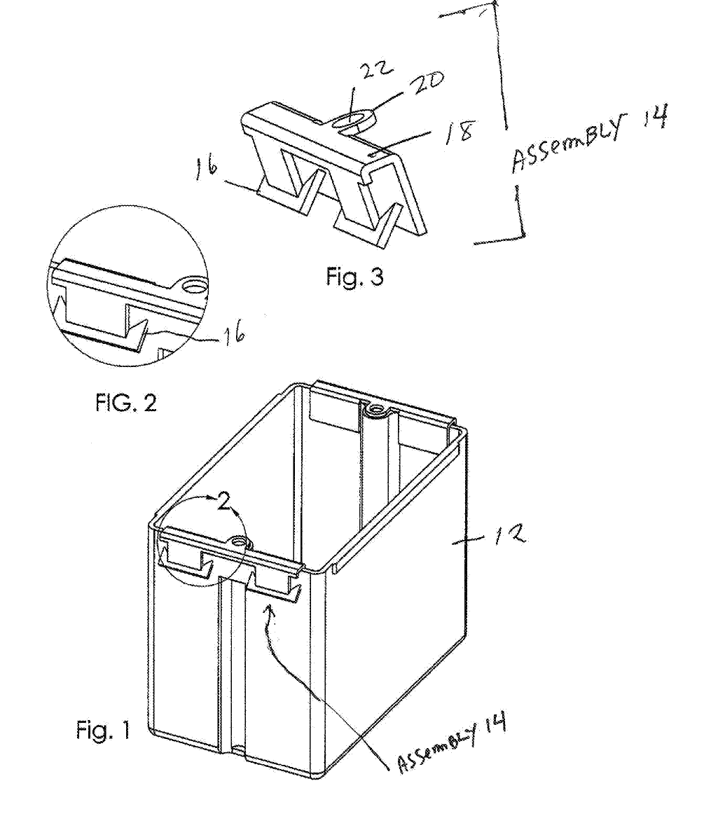

Attention is called to FIG. 1 which shows a wall case 12, preferably plastic, to which has been attached to the upper end of one of the walls the clip assembly 14, preferably made of metal such as steel. The details of the clip assembly are shown in

FIGS. 2 and 3. As can best be seen in FIGS. 2 and 3, the clip assembly comprises barbs 16 engaging the wall of the original box, which as previously stated is preferably made of metal. In the clip assembly 14 there is a bar 18 which engages an upper wall of the box 12. The bar 18 includes a tab 20 having a threaded opening 22.

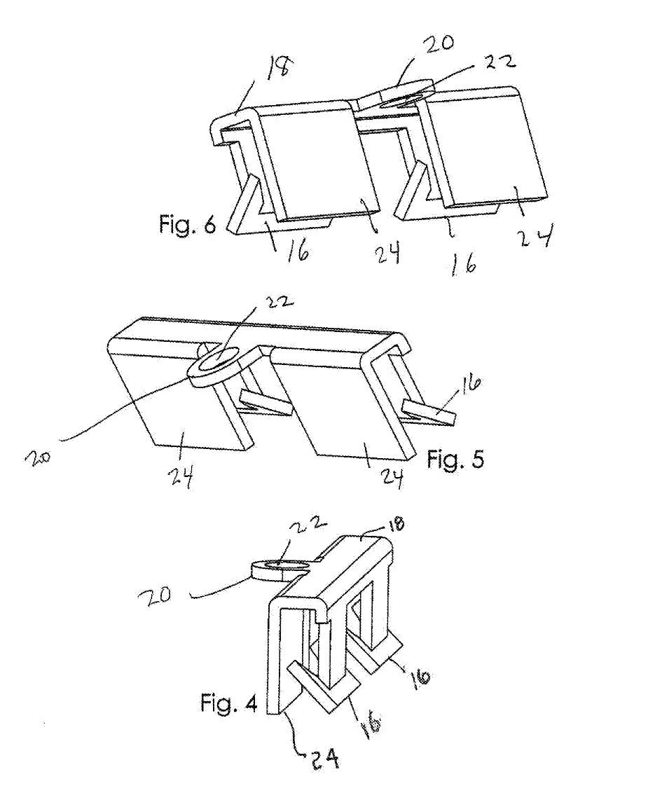

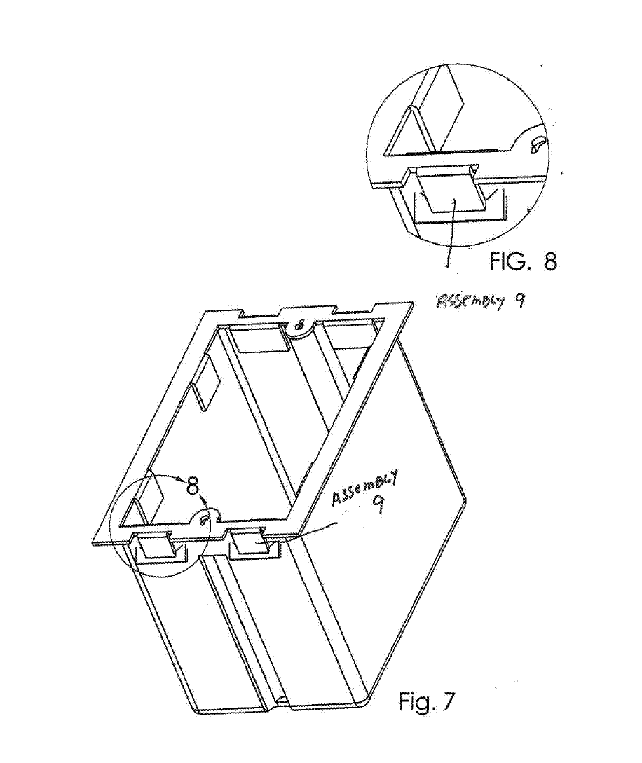

FIGS. 4, 5 and 6 are different views of the embodiment shown of FIG. 3 which will be referred to as the first embodiment of the invention.

FIGS. 7 and 8 are further views of the clip assembly 9.

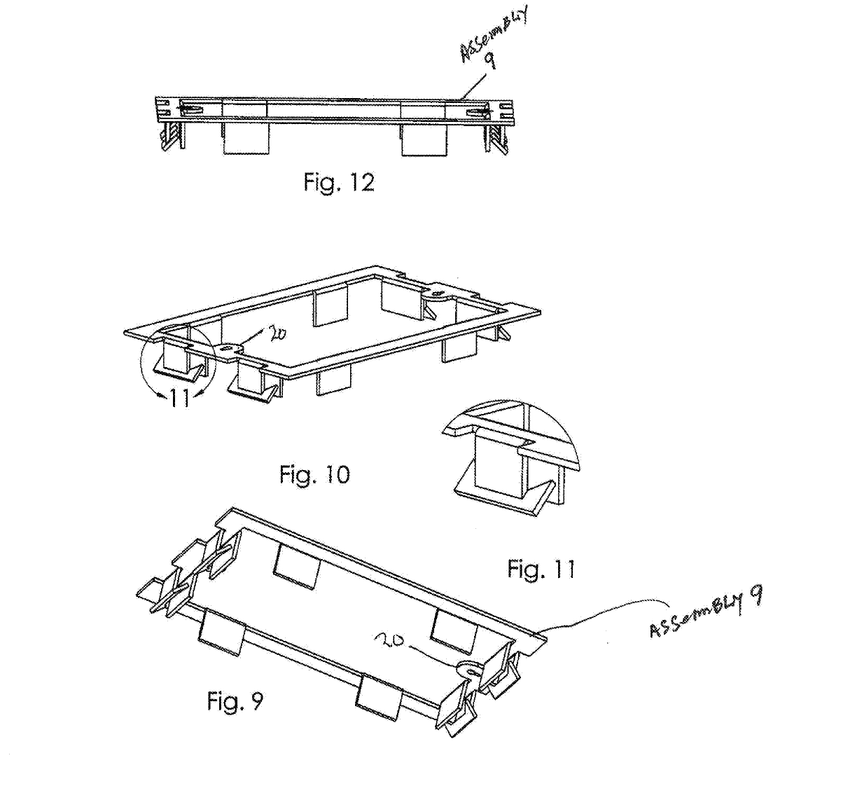

FIG. 9 shows the metal clip assembly by itself.

FIGS. 10, 11 and 12 show additional details of the metal clip assembly 9 of FIG. 9.

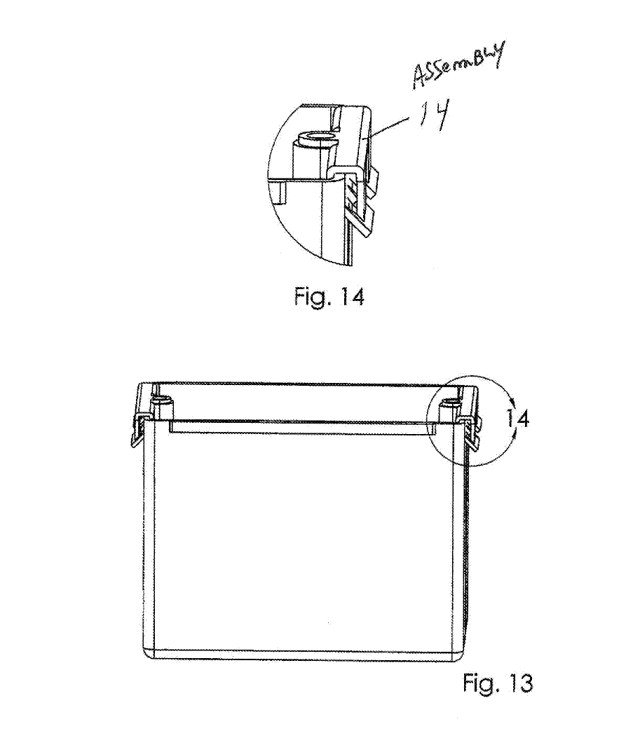

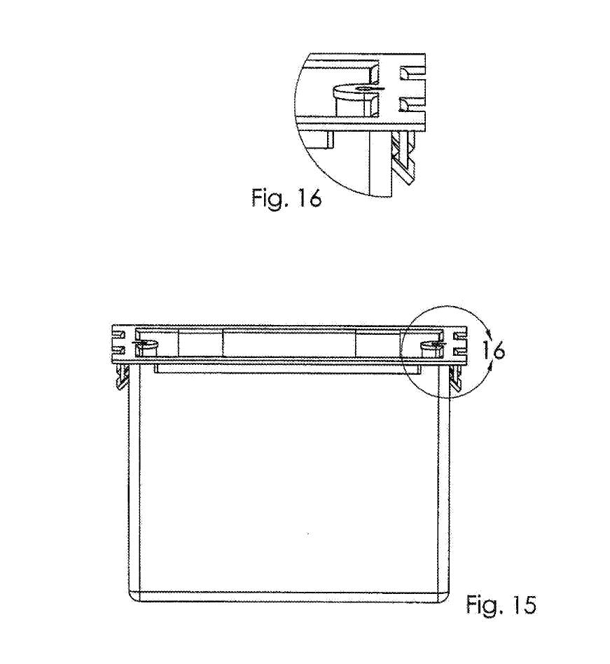

FIG. 12 is a side view of the metal clip assembly 9 of FIG. 9. FIG. 13 is a side view of the electrical box having the metal clip assembly 14 secured to it. FIG. 14 is a blow up of the metal clip assembly 14 taken from an end thereof. FIG. 15 is a view of the device of FIG. 7 taken from a different angle. FIG. 16 is a blow up view taken as shown of FIG. 15.

What is claimed is:

1. A clip assembly for use with electrical wall boxes having an outer and inner wall surface, said clip assembly having gripping means for engaging at least a portion of the outer or inner surface of said wall box, said gripping means having a barb extending outwardly from said clip assembly thereby to resist removal of said clip assembly, further including a tab having an opening to receive a machine screw.

2. The Clip Assembly of claim 1 wherein said opening is threaded

3. The clip assembly of claim 1 wherein said wall box is constructed of PVC, Plastic or other Resin for use in an electrical wiring system.

4. The clip assembly of claim 1 wherein said Barb and Tab are formed intricate with the clip assembly
